(19) United States
(12) Patent Application Publication
(10) Pub. No.: US 2026/0175745 A1
(43) Pub. Date: Jun. 25, 2026

(54) COVER, RAIL WITH A COVER AND VEHICLE SEAT

(71) Applicant: Adient US LLC, Plymouth, MI (US)

(72) Inventors: Erik SPRENGER, Wermelskirchen (DE); Ingo QUAST, Düsseldorf (DE)

(21) Appl. No.: 19/426,364

(22) Filed: Dec. 19, 2025

(30) Foreign Application Priority Data
Dec. 20, 2024 (DE) 10 2024 212 246.7
Apr. 16, 2025 (DE) 10 2025 114 960.7

(51) Int. Cl. B60N 2/07

(52) U.S. Cl. CPC B60N 2/0725; B60N 2/0705

(57) ABSTRACT

A cover for a rail of a longitudinal adjustment device may have at least one support in which a plurality of clips are integrated, which are spaced apart from one another in the longitudinal extent of the support. The respective clip being designed to be rotatable relative to the support and having a locking contour with a plurality of notches and/or steps. A rail with the cover and a vehicle seat are also provided.

### FIELD

The invention relates to a cover for a rail, a rail with such a cover and a vehicle seat having a longitudinal adjustment device having a rail with a cover.

### BACKGROUND

DE 10 2016 224 588 A1 discloses a longitudinal adjuster having a rail assembly, comprising a bottom rail and a top rail which is movably connected to the bottom rail. Furthermore disclosed is a cover (for example a rubber cover, a brush cover, etc.), which is connected to an outer profile of the bottom rail and which is arranged in such a way that it covers at least part of an inner profile.

The invention is based on the object of providing an improved cover of the type mentioned at the outset, in particular an easily mountable and securely fastenable cover for a rail, a rail with such an improved cover and a corresponding vehicle seat.

### SUMMARY

The first object is achieved according to the invention by a cover for a rail, the cover (also referred to as rail cover) comprising at least one support, in which a plurality of clips are integrated, which are spaced apart from one another in the longitudinal extent of the support, the respective clip being designed to be rotatable relative to the support and having a locking contour with a plurality of notches and/or steps.

As a result of the respective clip having a locking contour with a plurality of notches and/or steps, the clips may come into self-retaining and self-fastening, in particular self-locking, active engagement with the rail and may be held therein. As a result, the clip and therefore the cover are additionally prevented from becoming detached from, and/or lifted off, the rail. The locking contour with a plurality of notches and/or steps additionally prevents the clip from being pressed laterally outwards, i.e. away from the rail. The clip may remain in active engagement, in particular latching engagement, with an edge formed in and/or on the rail.

The respective clip is designed as a rotational wedge. The respective clip may be pivotable about a rotation axis oriented in the longitudinal extent.

At a free arm end of the clip or the rotational wedge, the locking contour is formed with a plurality of notches and/or steps. The respective clip comprises an arm end connected to the support and a free arm end having the locking contour.

The notches and/or steps are designed for receiving a top edge extending from the through-opening, in particular for latching engagement with said top edge. In particular, the locking contour is provided on the respective clip in order to come into self-retaining active engagement, in particular latching engagement, with a through-opening formed on the rail.

In particular, a multiplicity of notches and/or steps may form a corresponding multiplicity of latching steps or locking steps defined in the rotational direction of the rotational wedge.

The notches and/or steps, in particular locking steps or latching steps, are releasable at least in one of the two movement directions, in particular rotational directions, of the respective clip. The notches and/or steps protrude perpendicularly from the free arm end of the respective clip. The notches and/or steps protrude, for example, upwards (in the vertical direction) and therefore perpendicularly to the longitudinal direction. The notches and/or steps extend perpendicularly to the movement direction in each case.

The free arm end of the respective clip may have an arcuate design. The free arm end may have a wedge-shaped design, with integrated notches and/or steps at the outer end.

The notches and/or steps, in particular locking steps or latching steps, are releasable in both movement directions, in particular rotational directions, of the respective clip.

The respective clip has a self-locking and self-retaining function.

The respective clip may be pretensioned in a direction oriented perpendicularly to the longitudinal extent. The respective chip may designed to be elastic and/or reversibly flexible.

The support may be designed as a plastic profile. As a result, the cover may be manufactured in a simple tool, in particular in a plastic molding tool, with relatively low material usage and relatively small profile tolerances and together with integrated locking elements, designed as clips. The self-retaining, self-locking and self-fastening notches and/or steps on the respective clip prevent the plastic part from becoming lost. Each step and/or notch may define a stop region.

The respective clip may be pretensioned in the direction oriented perpendicularly to the longitudinal extent as a result of the elasticity of the plastic material of the support. As a result, the clips may be held pressed in the direction of the rail in each case.

The plastic profile may be arrangeable or arranged on the rail without play. Automatic locking of the clip, and therefore the support, on the rail may also be ensured.

The design of the support as a plastic profile enables the cover to be manufactured in a simple tool, in particular in a plastic molding tool, with relatively low material usage and relatively small profile tolerances and together with integrated locking elements designed as clips.

The clips may be lateral clips. The plastic profile may be attached laterally to a rail (also referred to as rail element) via clip connections. It is thus possible to attach the support designed as a plastic profile, also referred to as a plastic support, to only one lateral side of the rail, for example a bottom rail. Depending on the length of the rail, several of these supports may also be attached to the rail element in succession and on both sides.

As a result, it is possible to dispense with a conventional cover, which is guided around the rail, for example the bottom rail, from one side to the other side underneath the rail. Such a cover requires greater installation space and greater assembly effort and is subject to tolerances.

The respective clip may have at least one undercut, which is designed, in particular, as a rotational wedge. The rotation point may be arranged through a movable, in particular articulated, wedge portion of the rotational wedge.

The respective clip may be pivotable about a rotation point. The rotation point may be arranged through a movable, in particular articulated, wedge portion of the rotational wedge.

The plastic profile may have a plurality of cutouts, which are spaced apart from one another in the longitudinal extent. One clip may be associated with one cutout in each case. In particular, the respective rotational wedge may be formed by cutting or punching out an area in the plastic profile.

The respective clip may be arranged in a protruding manner on one side of the cutout. The respective clip may be connected to the cutout on this side and may form the rotation point. As a result, a single-part plastic support with integrated clips may be formed in a simple manner.

The plastic profile may have a plurality of recesses for a latching plate of the longitudinal adjustment device, in particular for receiving latching lugs, and/or for screen attachment of a screen. The clips and the recesses may be arranged in an alternating manner in the longitudinal extent of the plastic profile.

The support, in particular the plastic profile, may have at least one undercut. The undercut may be arranged at a spacing from the clips. The undercut may be aligned substantially parallel to the clips. The undercut may be provided to hold the plastic profile on the rail, for example against forces which may act in the transverse direction of extent of the rail.

The undercut may be formed by suitable shaping, in particular bending, at a free limb portion of the plastic profile.

The plastic profile may have a first limb portion and a second limb portion connected to the first limb portion and protruding perpendicularly. The undercut may be formed at a free limb end of the first limb portion. The plurality of clips may be integrated or formed in the second limb portion.

The plastic profile may have a substantially J-shaped design. Alternatively, the plastic profile may have a substantially L-shaped design.

The plastic profile may have a second limb portion which is longer than the first limb portion. The form of the plastic profile corresponds to a conventional form of a lateral side of a bottom rail. Such a bottom rail may have, for example, a rail base with two rail limbs protruding perpendicularly upwards, it being possible for the rail limbs to each be bent inwards at their free limb ends. The respective rail limb is also referred to as the lateral side.

The plastic profile may have a form corresponding to the respective rail limb. The plastic profile may be attached to the rail substantially with form-fit via the undercut and the lateral clip.

The plastic profile may have a first limb portion extending continuously in the longitudinal extent. Several second limb portions may protrude on the first limb portion. The limb portions may be spaced apart from one another in the longitudinal extent. The limb portions may have at least one clip or several clips in each case. Alternatively, the plastic profile may have a second limb portion with a continuous form in the longitudinal extent.

The plastic profile may have a continuous undercut extending in the longitudinal extent of the plastic profile. The undercut may be provided with interruptions.

The second object is achieved according to the invention by a rail, in particular by a bottom rail of a longitudinal adjustment device, the rail comprising the above-described cover and having a number of through-openings along the longitudinal extent, designed to correspond to the clips. By way of example, the respective clip may come into self-retaining active engagement with the associated through-opening via the rotational wedge, and via the notches and/or steps of the locking contour. In particular, the respective clip can be brought, or is brought, into self-retaining and self-locking engagement with the associated through-opening via the rotational wedge such that a pulling action, in particular a pulling force, on a free end of the cover does not result in the release the self-retaining and self-locking active engagement. By way of example, to this end, the cover may be arranged on the rail in such a way that it is pivotable about a predetermined rotation point of the rotational wedge.

The rail limb may have at least one free limb end, the undercut of the cover reaching around or behind the free limb end.

In addition, the cover may comprise a screen, which is releasably attachable to the support. The screen may be an optical cover screen. By way of example, the bottom rail may be arranged underneath a floor surface of the vehicle. A floor opening of the vehicle floor may be covered by the screen. The screen may be attached to the support via connecting elements. The screen may have connecting elements, which latch in recesses of the support. In a development, the screen may be provided to cover a rail opening between the rail limbs of the bottom rail.

The third object is achieved according to the invention by a vehicle seat, which comprises a longitudinal adjustment unit, which comprises the above-described rail, in particular bottom rail, with a cover.

Advantageous configurations, which may be used individually or in combination with one another, are described below.

### DESCRIPTION OF THE FIGURES

The invention is explained in more detail below with reference to advantageous exemplary embodiments illustrated in the figures. However, the invention is not restricted to these exemplary embodiments.

FIG. 1 shows a schematic illustration of a vehicle seat with a longitudinal adjustment device,

FIG. 2 shows a perspective view of a rail with a cover on both sides,

FIG. 3 shows a perspective view of a rail with a cover on one side,

FIG. 4 shows an enlarged detail of the perspective view of the rail in the region of a coupling between the rail and the cover,

FIG. 5 shows a sectional illustration of FIG. 4 in the region of a coupling between the rail and the cover,

FIG. 6 shows a further sectional illustration of FIG. 4 in the region of the coupling between the rail and the cover, the cover having at least one modified clip,

FIG. 7 shows an enlarged detail of FIG. 6 in the region of a locking contour of the clip,

FIG. 8 shows a front view of the rail with the cover on both sides, and

FIG. 9 shows a sectional illustration of FIG. 6 in the region of a coupling between the rail and both covers.

### DETAILED DESCRIPTION

Mutually corresponding parts are denoted by the same reference signs in all figures.

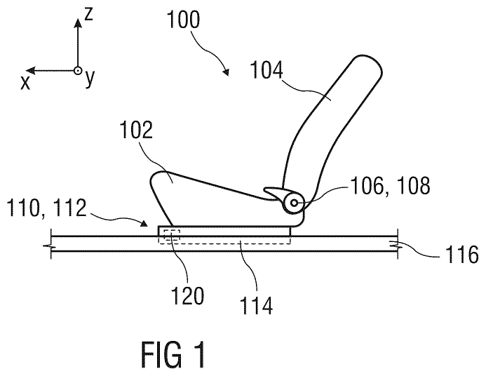

A vehicle seat 100 of the prior art, which is illustrated schematically in FIG. 1, is described below using three spatial directions extending perpendicularly to one another. In the case of a vehicle seat 100 which is installed in a vehicle, a longitudinal direction x extends substantially horizontally and preferably parallel to a vehicle longitudinal direction, which corresponds to the usual direction of travel of the vehicle. A transverse direction y, extending perpendicularly to the longitudinal direction x, is likewise aligned horizontally in the vehicle and extends parallel to a vehicle transverse direction. A vertical direction z extends perpendicularly to the longitudinal direction x and perpendicularly to the transverse direction y. In the case of a vehicle seat 100 which is installed in the vehicle, the vertical direction z extends preferably parallel to a vehicle vertical axis.

The positions and directions specified, for example front, rear, top and bottom, relate to the viewing direction of an occupant seated in the vehicle seat 100 in the normal seated position, the vehicle seat 100 being installed in the vehicle in a usage position which is suitable for passenger transportation, with an upright backrest 104, and being aligned in the customary manner in the direction of travel. However, the vehicle seat 100 may also be installed or moved with a different alignment, for example transversely to the direction of travel. Unless described otherwise, the vehicle seat 100 is designed to be mirror-symmetrical to a plane extending perpendicularly to the transverse direction y.

The backrest 104 may be pivotably arranged on a seat part 102 of the vehicle seat 100. To this end, the vehicle seat 100 may optionally comprise a fitting 106, in particular an adjustment fitting, rotational fitting, latching fitting or tumble fitting.

The positions and directions specified, for example radially, axially and in the circumferential direction, relate to a rotation axis 108 of the fitting 106. Radially means perpendicularly to the rotation axis 108. Axially means in the direction of or parallel to the rotation axis 108.

The vehicle seat 100 may optionally comprise a longitudinal adjustment device 110 (also referred to as longitudinal adjustment unit). The longitudinal adjustment device 110 comprises, for example, a rail assembly 112 having a first rail 114 (or a first rail element 114) and a second rail 116 (or a second rail element 116). The first rail 114 is adjustable in the longitudinal direction x relative to the second rail 116. The first rail 114 is attached to the seat part 102. The second rail 116 is attached to a structural element of a vehicle, for example a vehicle floor.

The first rail 114 may be referred to as the top rail 114. This top rail 114 (also referred to as running rail or slide) is associated with the vehicle seat 100 and is designed to support this vehicle seat 100. The second rail 116 may furthermore be referred to as the bottom rail 116. The bottom rail 116 is fixed and is connected, for example, to the floor of a vehicle or another suitable vehicle structure. The rail assembly 112 is provided with a cover 120.

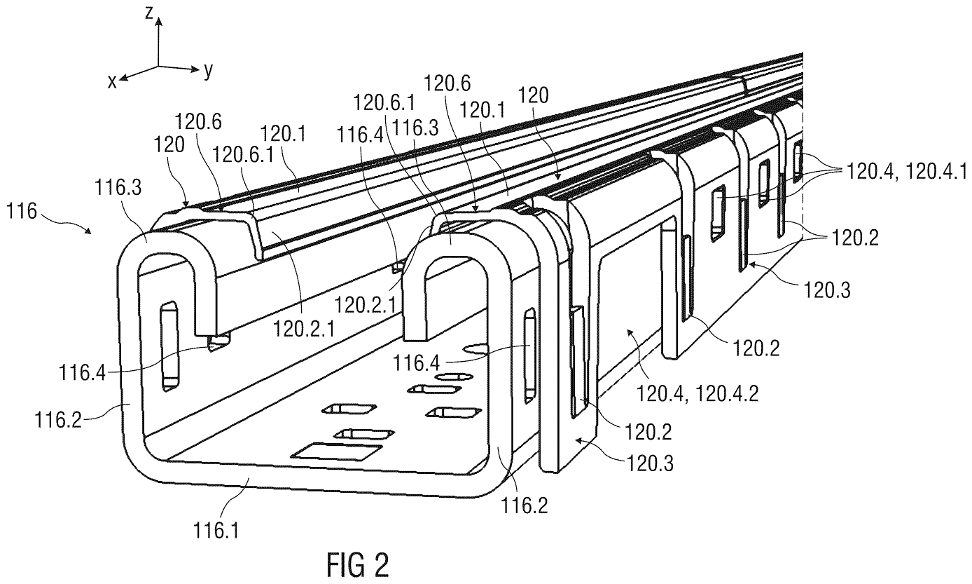

FIG. 2 shows a perspective view of a bottom rail 116 with a cover 120 on both sides.

The bottom rail 116 is designed, in particular, as a profile component, in particular a metal profile component. The bottom rail 116 may be designed, for example, as a U-shaped profile component with a rail base 116.1 from which two rail limbs 116.2 are formed perpendicularly upwards. Free limb ends 116.3 may be additionally bent inwards in a u shape.

The bottom rail 116 may comprise a cover 120 (also referred to as a rail cover) on each rail limb 116.2.

The respective cover 120 comprises at least one support 120.1, which is designed as a plastic profile.

As shown only for the front/right support 120.1 in FIG. 2, a plurality of clips 120.2 are integrated in the respective support 120.1 along its longitudinal extent (in the longitudinal direction x).

The clips 120.2 are incorporated in the associated support 120.1 at a spacing from one another in the longitudinal extent.

The design of the respective support 120.1 as a plastic profile enables the cover 120 to be manufactured in a simple tool, in particular in a plastic molding tool, with relatively low material usage and relatively small profile tolerances.

To mount and fasten the respective support 120.1, the bottom rail 116 comprises a number of through-openings 116.4 along the longitudinal extent, which are designed to correspond to the clips 120.2.

The clips 120.2 may be integrated in the support 120.1 at uniform spacings from one another. The bottom rail 116 has a number of through-openings 116.4 which at least corresponds to, or is greater than, the number of clips 120.2.

The respective support 102.1 is designed as an L-profile. The clips 120.2 are integrated in the limb portion 120.3 of the respective support 120.1, which bears against the associated rail limb 116.2 in the assembled state.

The clips 120.2 protrude from the support 120.1 in the direction of the rail limbs 116.2 and come into engagement with the associated through-opening 116.4. The clips 120.2 may be designed, for example, as resilient tabs or tongues.

The clips 120.2 may be integrated in the support 120.1 as punched tongues or the like.

The limb portion 120.3 may moreover comprise recesses 120.4. The recesses 120.4 may be designed as passages 120.4.1 and/or as cutouts 120.4.2, in particular as latching slots.

The clips 120.2 and the recesses 120.4 may be integrated in the limb portion 120.3 in an alternating manner in the longitudinal direction x. By way of example, the clips 120.2 and the recesses 120.4 may be integrated in the limb portion 120.3 at uniform spacings from one another.

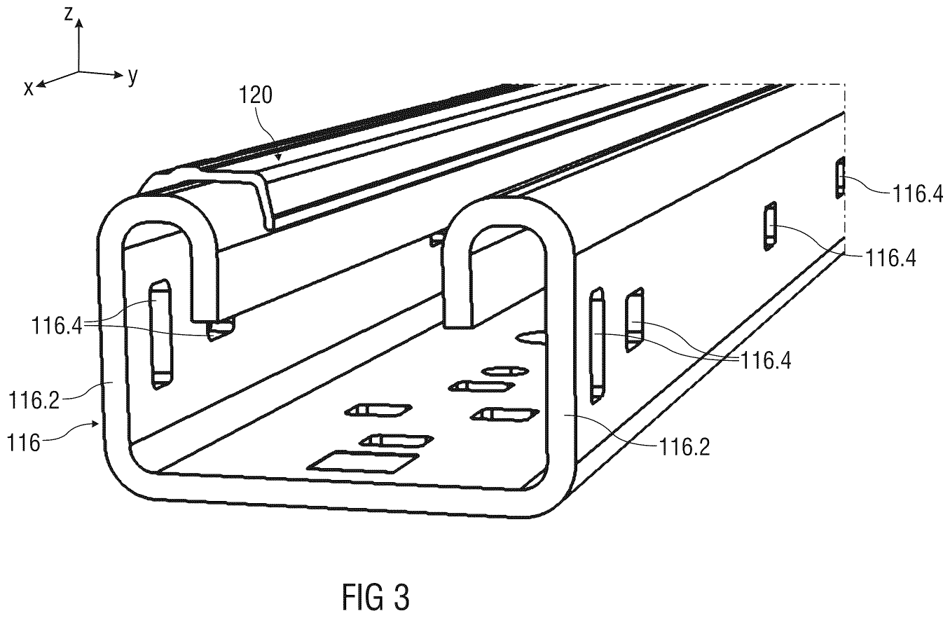

FIG. 3 shows a perspective view of the rail designed as a bottom rail 116 with a cover 120 on one side. The front/right cover 120 is omitted to better illustrate the through-openings 116.4 in the rail limb 116.2.

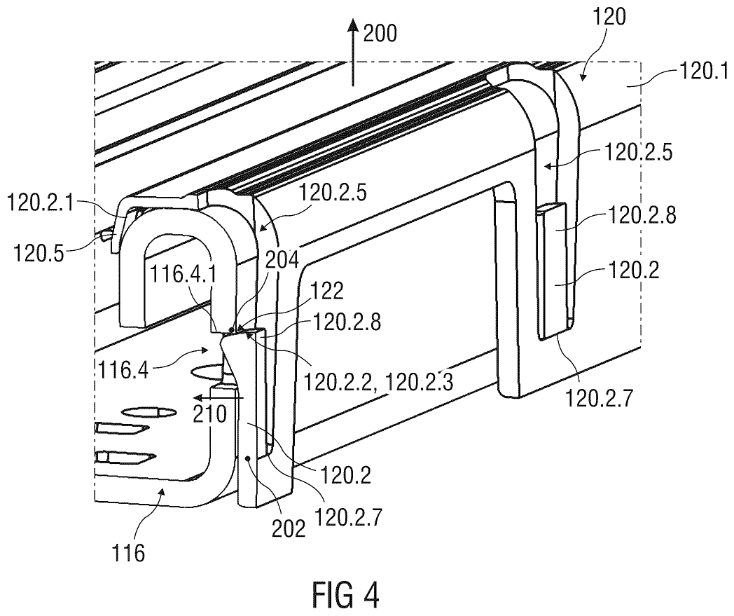

FIG. 4 shows an enlarged detail of the perspective view of the rail designed as a bottom rail 116 in the region of a coupling between the bottom rail 116 and the cover 120 via the clips 120.2 of the support 120.1 and the through-openings 116.4 in the bottom rail 116.

The respective clip 120.2 may have at least one undercut. The respective clip 120.2 may be designed as a rotational wedge 120.2.2.

By way of example, the respective clip 120.2 may come into self-retaining active engagement 122 with the associated through-opening 116.4, in particular at a top edge 116.4.1 (=upper opening edge), via the rotational wedge.

The support 120.1 comprises an undercut 120.2.1 for attaching or fastening the support 120.1 on the bottom rail 116. In the assembled state, the undercut 120.2.1 reaches behind or around a bottom rail structure. For example, the undercut 120.2.1 reaches behind or around a rail limb 116.2 of the bottom rail 116.

The undercut 120.2.1 prevents the cover 120 from rotating about a contact point 204 of the rotational wedge 120.2.2 on the top edge 116.4.1.

In other words: in the assembled state, the respective clip 120.2 is in self-retaining active engagement 122 with the associated through-opening 116.4 via the rotational wedge 120.2.2 such that a predetermined pull according to arrow 200 on a free end 120.5 of the cover 120 does not result in the release of the self-retaining active engagement 122. The clip 120.2 is designed, for example, as a spring clamp or a spring arm. The rotational wedge 120.2.2 is designed, for example, as a locking contour 120.2.3, in particular as a wedge surface, or has, for example, a ramp-shaped configuration or the like, at the free arm end 120.2.8.

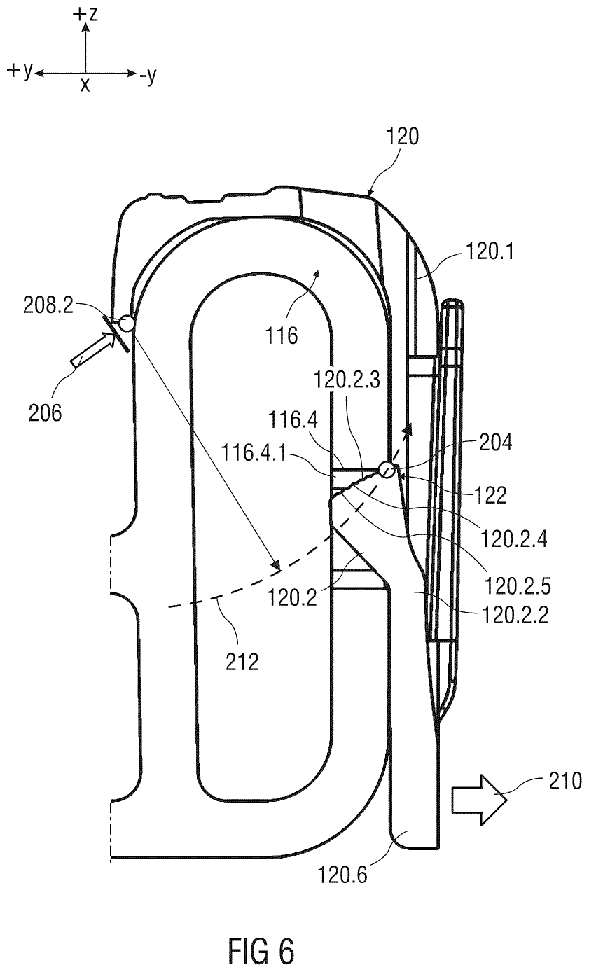

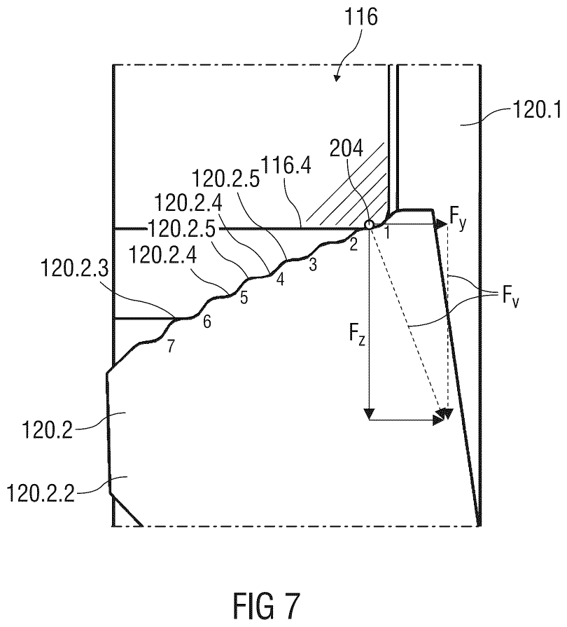

The respective clip 120.2 comprises an arm end 120.2.7 connected to the support 120.1 and a free arm end 120.2.8 having the locking contour 120.2.3. Notches 120.2.4 and/or steps 120.2.5 (illustrated in FIGS. 6 and 7) are integrated in the free arm end 120.2.8 as a locking contour 120.2.3.

During the assembly of the support 120.1 on the rail limb 116.2, the clip 120.2 engages in the through opening 116.4, and therefore in a wall of the rail limb 116.2, in the radial direction and comes into self-retaining active engagement 122 with the top edge 116.4.1, in particular through friction-fit and/or force-fit, so that the bottom rail 116 and the cover 120 are fastened to one another against slipping or twisting.

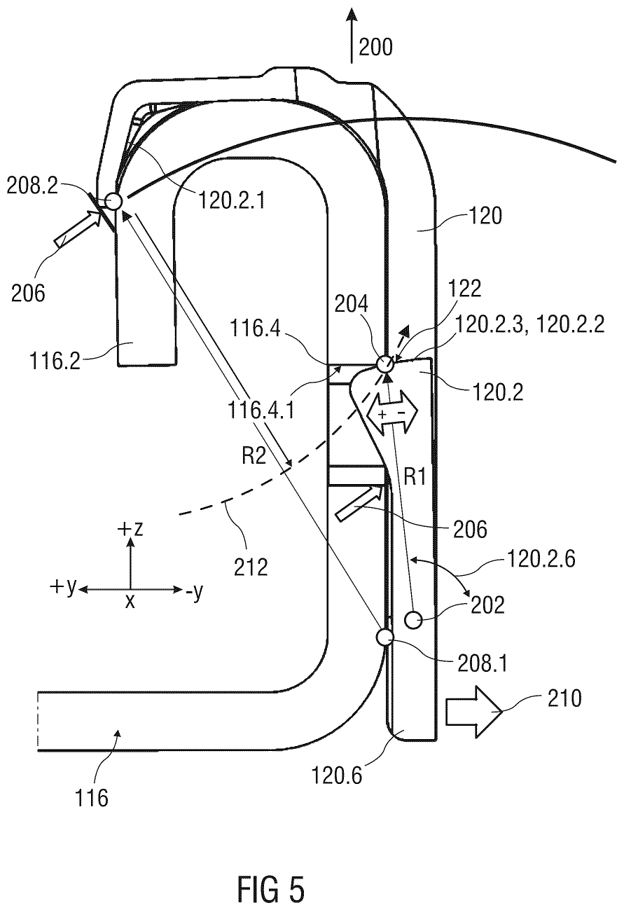

In particular, the cover 120 is arranged on the bottom rail 116 in such a way that it is pivotable about a predetermined rotation point 202 of the rotational wedge 120.2.2 and, upon the attempted release of the connection at the bottom rail 116, for example via a pull in the direction in the arrow 200, this cover 120 is supported at at least one point, in particular over a length seen along a line at the bearing points 208.1, 208.2 (illustrated in FIG. 5). This at least one bearing point 208.1, 208.2 or this at least one line (entire support 120.1 (=plastic support)) may be seen, as it were, as a rotation point 202 or rotation axis 108. The undercut 120.2.1 prevents this rotation about this rotation point 202 or this rotation axis 108.

FIG. 5 shows a sectional illustration of FIG. 4 in the region of the coupling between the bottom rail 116 and the cover 120 in the form of the clip connection and the holding function.

The at least one clip 120.2 is arranged so that an upward pull according to arrow 200 in the vertical direction +z cannot result in the release of the clip connection.

The clip 120.2 comprises the rotational wedge 120.2.2, which has the locking contour 120.2.3. The rotational wedge 120.2.2 is rotatable about the rotation point 202. Out of the tool, the clip 120.2 is positioned in the transverse direction +y. During assembly, this position of the clip 120.2 may be changed, or become changed, as a result of the contact, in particular the active engagement 122, with the top edge 116.4.1 of the through-opening 116.4 at the contact point 204. In particular, the multiplicity of notches 120.2.4 and/or steps 120.2.5 (illustrated in FIGS. 6 and 7) may form a corresponding multiplicity of latching steps or locking steps with contact points 204, which are defined in the rotational direction 120.2.6 of the rotational wedge 120.2.2.

The contact point 204 may be further along the transverse direction +y if tolerances cause a through-opening 116.4 to move upwards, for example, and further along the transverse direction −y if the position of the through-opening 116.4 is in the opposite direction. In the event of tolerance-induced positional changes in the vertical direction z, the contact point 204 does not change position. However, the clip 120.2 itself changes position in the transverse direction y in the manner described.

The rotational wedge 120.2.2 with the locking contour 120.2.3 may be pivoted about the rotation point 202. Due to the elasticity of the plastic of the cover 120, this rotational wedge 120.2.2 is always pressed against the top edge (116.4.1 (=upper edge) of the through-opening 116.4 (also referred to as hole pattern). The cover 120 (also referred to as cover screen) is therefore without play in the vertical direction +z.

If an attempt is made to lift the cover 120 in the vertical direction +z according to arrow 200, the clip 120.2 will not open since the rotational wedge 120.2.2 is designed to be self-retaining.

If someone attempts to move the cover 120, in particular the support 120.1, laterally in the direction according to arrow 206, this is prevented via the undercut 120.2.1 of the profile. This means that, if a force is applied in the direction according to arrow 206, the support 120.1 designed as a plastic support bears against the bottom rail 116 at a first bearing point 208.1 and at a second bearing point 208.2. The first bearing point 208.1 and the second bearing point 208.2 are formed on opposite outer sides of the rail limb 116.2.

A notional rotation about the first bearing point 208.1 is not possible since the second bearing point 208.2 cannot migrate along the rail contour since the clip 120.2 at the contact point 204 on the top edge 116.4.1 of the through-opening 116.4 prevents any movement in the vertical direction z.

To reinforce the self-retaining active engagement 122, the locking contour 120.2.3 may be provided with a plurality of notches 120.2.4 and/or steps 120.2.5 (not illustrated in more detail in FIGS. 6 and 7).

This prevents the clip 120.2 from being pressed laterally outwards (in the movement direction according to arrow 212) in the event of a force effect on a bottom end 120.6 of the support 120.1 in the direction according to arrow 210.

FIG. 6 shows a further sectional illustration of FIG. 4 in the region of the coupling between the bottom rail 116 and the cover 120, the cover 120 having at least one modified clip 120.2.

The clip 120.2 is designed as a rotational wedge 120.2.2, a locking contour 120.2.3 with a plurality of notches 120.2.4 and/or steps 120.2.5 being formed in the transverse extent of the support 120.2 at a free arm end 120.2.8 of the clip 120.2 or the rotational wedge 120.2.2. During assembly, the locking contour 120.2.3 may come into active engagement 122, in particular latching engagement, step by step, with the top edge 116.4.1 and define a contact point 204 with the top edge 116.4.1 at each notch 120.2.4 and/or step 120.2.5. The notches 120.2.4 and/or steps 120.2.5 prevent the cover 120 from becoming detached from the bottom rail 116.

The locking contour 120.2.3, in particular designed as a wedge surface and contact surface, has a ramp-shaped configuration and is provided with notches 120.2.4 and/or steps 120.2.5. As a result of the notches 120.2.4 and/or steps 120.2.5, the locking contour 120.2.3 may have an undulating and uneven form as seen in section.

The notches 120.2.4 and/or steps 120.2.5 are designed for receiving the top edge 116.4.1 extending along the through-opening 116.4. In particular, the multiplicity of notches 120.2.4, in particular undulating or sinusoidal notch profiles, and/or steps 120.2.5, in particular sawtooth steps, may form a corresponding multiplicity of latching steps or locking steps, which are defined in the rotational direction 120.2.6 of the rotational wedge 120.2.2.

A movement in the movement direction according to arrow 212 may be thwarted as a result of the locking contour 120.2.3 having a plurality of notches 120.2.4 and/or steps 120.2.5.

FIG. 7 shows an enlarged detail of FIG. 6 in the region of a locking contour 120.2.3 of the clip 120.2.

The enlarged detail shows a comparison of forces Fy, Fz.

A normal force vector Fv (shown by dashed lines) may be produced as a result of a planar, inclined and smooth contact surface of a locking contour 120.2.3. As a result, the clip 120.2 may be acted upon by a force Fy which may move the clip 120.2 in the opening direction. In this case, a clip 120.2 may be released from the top edge 116.4.1 of the bottom rail 116 more easily and may slide laterally.

The modified locking contour 120.2.3, in particular in the form of an undulating contour, may have, for example, a plurality of notches 120.2.4 and/or steps 120.2.5 or undulations (seven being shown here), which each define a stop region after a small pivot angle of the clip 120.2. A force vector in the contact point 204 may point in the z direction here. Release forces Fy are therefore not in effect. The clip 120.2. may thus be prevented from sliding in the contact point 204. The elasticity of the clip 120.2 may simply result in a slight yielding in the y direction. With self-retaining notches 120.2.4 and/or steps 120.2.5, the support 120.1 and therefore the cover 120 may be prevented from becoming lost.

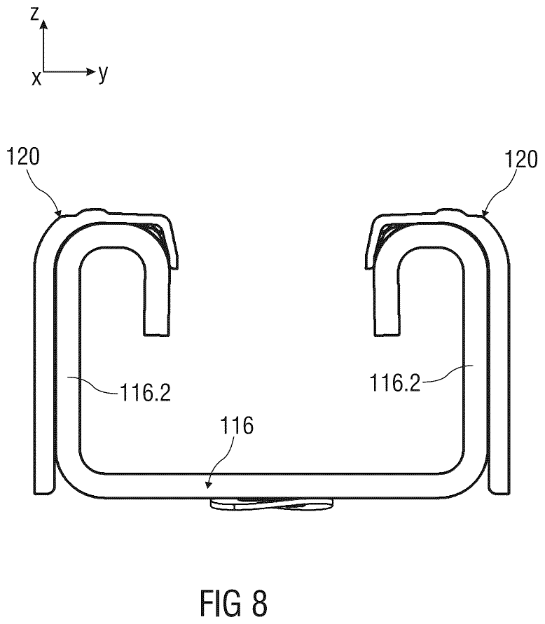

FIG. 8 shows a front view of a bottom rail 116 with the cover 120 on both sides. An associated cover 120 is arranged on each rail limb 116.2, which cover, as described above, is held on the rail limbs 116.2 in a self-retaining manner via a plurality of clips 120.2 (illustrated in FIG. 5) and is fastened without play in the vertical direction z.

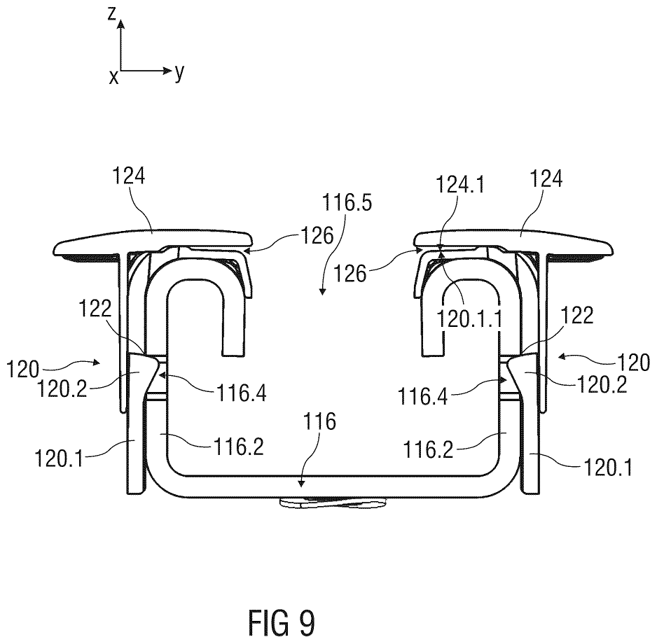

FIG. 9 shows a sectional illustration of FIG. 8 in the region of the coupling between the bottom rail 116 and the two covers 120 via the clips 120.2, which are in self-retaining active engagement with the through-openings 116.4 of the bottom rail 116.

The respective cover 120 may optionally further comprise a screen 124, in particular a T-shaped plastic screen.

The screen 124 may in turn be securely connected to the support 120.1 designed as a plastic support 120.1 in a releasable manner via further clip connections and guides (not illustrated).

To cover a rail opening 116.5 formed between the two rail limbs 116.2, a spiral spring (not illustrated in more detail) may be provided. To guide the spiral spring, in particular a leaf spring, a guide 126 is formed between the screen 124 and the support 120.1, adjacent to the rail opening 116.5. A bottom side 124.1 of the screen 124 forms an upper sliding surface or upper guide surface and a top side 120.1.1 of the support 120.1 forms a lower sliding surface or lower guide surface for the spiral spring.

### LIST OF REFERENCE SIGNS

100 Vehicle seat
102 Seat part
104 Backrest
106 Fitting
108 Rotation axis
110 Longitudinal adjustment device
112 Rail assembly
114 First rail (in particular top rail)
116 Second rail (in particular bottom rail)
116.1 Rail base
116.2 Rail limb
116.3 Limb end
116.4 Through-opening
116.5 Top edge (upper opening edge)
116.5 Rail opening
120 Cover
120.1 Support
120.1. Top side
120.2 Clip
120.2.1 Undercut
120.2.2 Rotational wedge
120.2.3 Locking contour
120.2.4 Notch
120.2.5 Step
120.2.6 Rotational direction
120.2.7 Arm end
120.2.8 Free arm end
120.3 Limb portion
120.4 Recess
120.4.1 Passage
120.4.2 Cutout
120.5 Free end
120.6 Lower end
122 Self-retaining active engagement
124 Screen
124.1 Bottom side
126 Guide
200 Arrow
202 Rotation point
204 Contact point
206 Arrow
208.1 First bearing point
208.2 Second bearing point
210 Arrow
212 Arrow
Fy, Fz Force
Fv Normal force vector
x Longitudinal direction
y, +y, −y Transverse direction
z, +z Vertical direction

1. A cover for a rail of a longitudinal adjustment device, comprising: at least one support, in which a plurality of clips are integrated, which are spaced apart from one another in the longitudinal extent of the support, the respective clip being designed to be rotatable relative to the support and having a locking contour with a plurality of notches and/or steps.

2. The cover as claimed in claim 1, wherein the locking contour is provided on the respective clip in order to come into self-retaining active engagement with a through-opening formed on the bottom rail.

3. The cover as claimed in claim 1, wherein the notches and/or steps form a multiplicity of locking steps in the rotational direction of the respective clip.

4. The cover as claimed in claim 1, wherein the respective clip comprises an arm end connected to the support and a free arm end having the locking contour.

5. The cover as claimed in claim 1, wherein the respective clip is pretensioned in a direction oriented perpendicularly to the longitudinal extent.

6. The cover as claimed in claim 1, wherein the respective clip is designed as a rotational wedge.

7. The cover as claimed in claim 1, wherein the respective clip is arranged on the support so as to be pivotable about a rotation point.

8. The cover as claimed in claim 1, wherein the support is designed as a plastic profile.

9. The cover as claimed in claim 1, wherein the support has a plurality of cutouts, which are spaced apart from one another in the longitudinal extent, one clip being associated with one cutout in each case and the respective clip being arranged in a protruding manner on one side of the cutout.

10. The cover as claimed in claim 1, wherein the support has at least one undercut for fastening the support on the bottom rail, which undercut is arranged at a spacing from the clips and is aligned substantially parallel thereto.

11. A rail for the longitudinal adjustment device, comprising at least one rail base and two rail limbs protruding perpendicularly therefrom and at least one cover as claimed in claim 1, which is arranged on one of the two rail limbs.

12. The rail as claimed in claim 11, wherein the rail limb has a number of through-openings along its longitudinal extent, which are designed to correspond to the clips of the cover.

13. The rail as claimed in claim 12, wherein the respective clip comes into self-retaining active engagement with a top edge in the associated through-opening via the notches and/or steps.

14. The rail as claimed in claim 11, wherein the rail limb has a free limb end, the undercut of the cover reaching around or behind the free limb end.

15. A vehicle seat having the longitudinal adjustment device for longitudinal adjustment of the vehicle seat, the longitudinal adjustment device comprising at least one rail assembly having at least one first rail and a second rail as claimed in claim 11.
